(19) United States
(12) Patent Application Publication
(10) Pub. No.: US 2024/0420607 A1
(43) Pub. Date: Dec. 19, 2024

(54) STEREOSCOPIC IMAGE DISPLAY SYSTEM

(71) Applicant: YAZAKI CORPORATION, Tokyo (JP)

(72) Inventors: Takeshi Ishikawa, Makinohara-shi (JP); Yuki Ebata, Makinohara-shi (JP); Eri Moriyama, Makinohara-shi (JP)

(21) Appl. No.: 18/814,427

(22) Filed: Aug. 23, 2024

Related U.S. Application Data
(63) Continuation of application No. PCT/JP2023/011666, filed on Mar. 23, 2023.

(30) Foreign Application Priority Data
Mar. 28, 2022 (JP) 2022-052162

(51) Int. Cl. G09G 3/00

(52) U.S. Cl. CPC G09G 3/003; G09G 2354/00

(57) ABSTRACT

A stereoscopic image generation device for generating stereoscopic image data of a wire harness based on design data and a projection unit for projecting two stereoscopic images based on the stereoscopic image data into a VR space are included. First stereoscopic image data representing a wire harness in a state of being developed on a jig plate and second stereoscopic image data representing a wire harness in a state of being assembled to a vehicle are prepared as stereoscopic image data. The projection unit aligns and projects a first stereoscopic image based on the first stereoscopic image data and a second stereoscopic image based on the second stereoscopic image data in such a manner that the first stereoscopic image and the second stereoscopic image are positioned adjacent to each other.

### CROSS-REFERENCE TO RELATED APPLICATIONS

This is a continuation of International Application No. PCT/JP2023/011666 filed on Mar. 23, 2023, and claims priority from Japanese Patent Application No. 2022-052162 filed on Mar. 28, 2022, the entire content of which is incorporated herein by reference.

### TECHNICAL FIELD

The present disclosure relates to a stereoscopic image display system that can be used when a company or the like develops various products.

### BACKGROUND ART

For example, a cable movable range display device disclosed in Patent Literature 1 includes: a reality space information acquisition unit that acquires reality space information related to a reality space; a user position and posture estimation unit that obtains a position and a posture of a user from the reality space information; a simulation unit that receives wiring route information indicating a starting end, a passing point, and a terminal end of a wiring route and cable information indicating an allowable bending radius of a cable and a length of the cable and calculates a cable movable range from the wiring route information and the cable information; an image generation unit that generates a cable movable range image of virtual reality indicating a cable movable range in a reality space from the cable movable range calculated by the simulation unit and the position and posture obtained by the user position and posture estimation unit; and an image display unit that displays a cable movable range image of the virtual reality.

In a cooperative virtual reality online conferencing platform disclosed in Patent Literature 2, a conference on site is replaced with a conference in a common virtual space in virtual reality (VR). The platform includes three-dimensional (3D) point group data defining a virtual space, identifiers of a plurality of conference participants, and conference data including positions of a plurality of avatars corresponding to the conference participants in a virtual space. Further, the platform includes a processor that executes an instruction to start an online conference of the plurality of conference participants. A step of starting the online conference includes a step of providing an address of a 3D point group to each conference participant, and a step of transmitting 3D point group data and conference data to each conference participant. A current place of each avatar in the virtual space is transmitted to all the conference participants.

### CITATION LIST

### Patent Literature

Patent Literature 1: WO2018/020568
Patent Literature 2: JP2019-82997A

### SUMMARY OF INVENTION

When a company or the like develops various products, it may be preferable that a plurality of persons in charge who are present at a plurality of sites of the same company or a related company simultaneously gather at the same place, and examine a specific product.

For example, in a case where a product of a wire harness to be mounted on a vehicle is newly developed or a specification of an existing product is changed, persons in charge who are present at a department in charge of a vehicle manufacturer, a design department of a component company that manufactures a wire harness, a manufacturing department in each location of a component company, a manufacturing factory of overseas places of a component company, and the like gather at the same place, and persons in charge in the respective departments give the opinions from the respective standpoints and determine an appropriate specification and the like.

Specifically, when determining a routing path and a shape of a wire harness, a layout of a jig used for manufacturing the wire harness, and the like, the person in charge of the vehicle manufacturer needs to examine from a viewpoint of the ease of assembling the wire harness to the vehicle. In addition, the person in charge of design of the component manufacturer needs to examine from a viewpoint of a component cost or a manufacturing cost of the wire harness. The person in charge of the manufacturing department of the component manufacturer needs to examine from a viewpoint of the ease of manufacturing the wire harness.

For example, in the component manufacturer that manufactures a product of a wire harness, a wire harness is generally manufactured using a jig plate having a flat plate shape. That is, a large number of jigs for determining a reference position of each part of the routing path are disposed side by side on the jig plate, and a group of components such as a large number of electric wires are sequentially disposed and laminated on the jig plate such that a worker or the like passes through a predetermined routing path along each jig, thereby assembling a wire harness which is a three-dimensional structure. Therefore, an outer shape of a wire harness manufactured by the component manufacturer basically has a three-dimensional structure with a relatively small change in shape in a vertical direction and a relatively small undulation.

On the other hand, a vehicle body of the vehicle on which the wire harness is mounted has a very complicated three-dimensional structure, and a position where each of a large number of electric components mounted on the vehicle body is disposed is also individually determined as necessary in a three-dimensional space on the vehicle body. Therefore, an outer shape of the wire harness assembled and actually routed on the vehicle is a three-dimensional structure having a large change in shape in the vertical direction and rich in undulations so that many electric components can be connected to each other on the vehicle.

That is, in general, a three-dimensional shape of the wire harness manufactured by the component manufacturer is greatly different from a three-dimensional shape of the wire harness actually assembled to the vehicle. Therefore, for example, a difference may occur between a three-dimensional structure of a wire harness grasped by a designer of the component manufacturer and a three-dimensional structure of a wire harness grasped by a designer of the vehicle manufacturer.

For example, when a design specification presented by the designer of the vehicle manufacturer has contents that cause a problem at the time of manufacturing the wire harness, reexamination is required to change the design specification. In addition, when a design specification presented by the component manufacturer of the wire harness has contents that cause a problem when the wire harness is assembled to the vehicle, reexamination is required to change the design specification.

As described above, when the persons in charge at a plurality of independent sites perform an examination at another place, a difference in the opinions between the sites is likely to occur, and a change in specification or the like is likely to be repeated many times. In particular, when the person in charge at each site examines the content of a two-dimensional drawing, it is difficult to grasp an actual three-dimensional shape of each part of the wire harness, and it is difficult to find a problematic place.

Therefore, the persons in charge at the plurality of sites simultaneously gather at the same place, and, for example, persons in charge at all the sites simultaneously examine while viewing an actual model of the wire harness or an actual jig disposed on one work table. Accordingly, the number of times repeating to change a manufacturing specification of the wire harness or the like may be reduced, and the development efficiency may be improved.

For example, when the technique of Patent Literature 1 is employed, the cable movable range of the cable to be wired can be displayed to overlap the reality space. However, it is not possible to display information satisfying both the specification of the three-dimensional shape and the like required for manufacturing the component manufacturer of the wire harness and the specification of the three-dimensional shape or the like when the wire harness is actually assembled to the vehicle body.

For example, when the VR system disclosed in Patent Literature 2 is adopted, even if persons in charge at various sites do not move and gather in one place, three-dimensional shapes of the same product may be simultaneously grasped on screens of different computers. However, it is not possible to display information satisfying both the specification of the three-dimensional shape and the like required for manufacturing the component manufacturer of the wire harness and the specification of the three-dimensional shape or the like when the wire harness is actually assembled to the vehicle body. During the conference, it is not possible to change the specification of the product or the like by reflecting an opinion of each person in charge, and it is also not possible to view a change result. Therefore, it is necessary to repeat the conference several times each time a change is required, and an efficient conference cannot be held.

The present disclosure has been made in view of the above-described circumstances, and an object of the present disclosure is to provide a stereoscopic image display system that is useful for grasping a three-dimensional shape at least under both conditions of a specification in a situation at the time of manufacturing a wire harness and a specification in a situation at the time of assembling the wire harness to a vehicle.

The above object according to the present disclosure is achieved by the following configuration.

A stereoscopic image display system includes:
a stereoscopic image generation device configured to generate stereoscopic image data of a wire harness based on design data of the wire harness; and
a projection unit configured to acquire the stereoscopic image data from the stereoscopic image generation device and project a stereoscopic image based on the stereoscopic image data into a VR space that can be recognized by a user, in which
the stereoscopic image data includes first stereoscopic image data representing the wire harness in a state of being developed on a jig plate and second stereoscopic image data representing the wire harness in a state of being assembled to a vehicle, and
the projection unit aligns and projects a first stereoscopic image based on the first stereoscopic image data and a second stereoscopic image based on the second stereoscopic image data in such a manner that the first stereoscopic image and the second stereoscopic image are positioned adjacent to each other.

The projection unit projects the first stereoscopic image and the second stereoscopic image in such a manner that a first reference plane in the first stereoscopic image and a second reference plane in the second stereoscopic image are aligned in parallel with each other in a state where the reference planes are separated from each other by at least a certain distance in a vertical direction.

According to a stereoscopic image display system of the present disclosure, a user can easily grasp a three-dimensional shape and the like from a display content under both conditions of a specification in a situation at the time of manufacturing a wire harness and a specification in a situation at the time of assembling the wire harness to a vehicle. That is, since the first stereoscopic image and the second stereoscopic image are disposed so as to be aligned with each other in the stereoscopic images projected by the projection unit and are simultaneously displayed, the user can simultaneously grasp the three-dimensional shape in the situation at the time of manufacturing the wire harness and the three-dimensional shape in the situation at the time of assembling the wire harness to the vehicle in a comparable state.

### BRIEF DESCRIPTION OF DRAWINGS

FIG. 1 is a schematic diagram showing a situation of an online conference using a stereoscopic image display system according to an embodiment of the present disclosure;

FIG. 2 is a block diagram showing a configuration example of a VR conferencing system;

FIG. 3 is a block diagram showing a configuration example of a conferencing management server and a projection unit;

FIG. 4 is a flowchart showing a flow of processes in an operation example of the VR conferencing system;

FIG. 5 is a schematic diagram showing a representative example of a stereoscopic image formed in a VR examination place;

FIG. 6 is a schematic diagram showing an example of two reference planes that determine a positional relation between a first stereoscopic image and a second stereoscopic image;

FIG. 7 is a flowchart showing an example of a process for a display operation of a user; and

FIG. 8 is a flowchart showing an example of a process corresponding to a change operation of the user.

### DESCRIPTION OF EMBODIMENTS

A specific embodiment according to the present disclosure will be described below with reference to the drawings.

### <Situation of Online Conference>

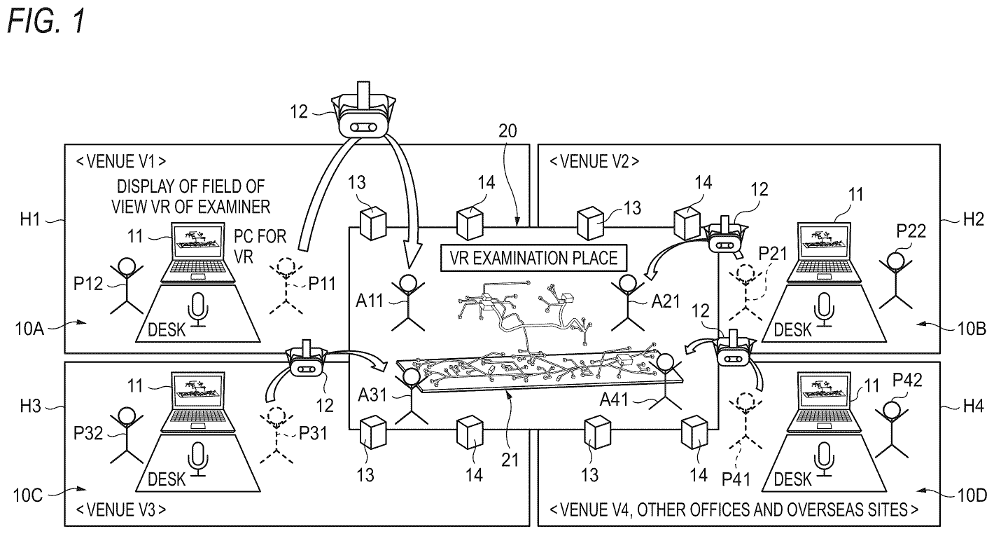

FIG. 1 is a schematic diagram showing a situation of an online conference using a stereoscopic image display system according to an embodiment of the present disclosure.

For example, in a case of developing a product of a wire harness to be mounted on an automobile, in order to improve the efficiency of product development, a large number of persons in charge who belong to, for example, a design site in a company group that provides a product of a wire harness, a manufacturing site in Japan, a manufacturing site in foreign countries, and a design site of an automobile company that manufactures a vehicle equipped with a manufactured wire harness simultaneously participate in the same conference and examine the product.

Here, when a product of a wire harness is developed, it is necessary to appropriately determine a three-dimensional shape of each part of the wire harness so as to pass through an appropriate routing path in accordance with a structure of a vehicle body to be mounted and an arrangement state of various electric components. Further, it is necessary to appropriately determine a layout of jigs used when manufacturing the wire harness in accordance with the three-dimensional shape of each part of the wire harness. It is necessary to appropriately determine a manufacturing procedure and the like in consideration of the work efficiency of a manufacturing process of the wire harness. Further, it is necessary to appropriately determine a branch position, an electric wire length, and the like of the wire harness so that a component cost of each electric wire or the like constituting the wire harness can be reduced.

Therefore, a person in charge at each site needs to examine from a unique viewpoint to be considered by each person in charge while grasping the three-dimensional shape of each part of the wire harness to be designed. Therefore, in general, after a real model or the like is prepared, persons in charge at all sites move and gather in the same examination place, and all members examine while viewing the same real model and the like at the same place. Accordingly, the efficiency of the conference can be increased. However, since there are many cases where each site is present at a place separated from each other by a distance such as overseas, a burden such as time and costs required for moving to hold a conference becomes extremely large.

In the case of using the VR conferencing system according to the embodiment, for example, by holding a conference using a VR examination place 20 shown in FIG. 1, an online conference can be held without movement of a person in charge at each site.

In the example shown in FIG. 1, it is assumed that a plurality of persons in charge present in each of the independent four sites H1, H2, H3, and H4 simultaneously gather in the common VR examination place 20 and hold an examination conference. The sites H1, H2, H3, and H4 correspond to, for example, a design site in a company group that provides a product of a wire harness, a manufacturing site in Japan, a manufacturing site in foreign countries, and a design site of an automobile company that manufactures a vehicle equipped with a manufactured wire harness.

There is an actual venue V1 for an examination conference at a specific place in the site H1. Similarly, at a specific place in each of the sites H2, H3, and H4, actual venues V2, V3, and V4 for an examination conference are present.

In the example shown in FIG. 1, one or more examiners P11 and one or more participants P12 are present in the venue V1. Similarly, one or more examiners P21 and one or more participants P22 are present in the venue V2. In addition, one or more examiners P31 and one or more participants P32 are present in the venue V3. One or more examiners P41 and one or more participants P42 are present in the venue V4.

In the venue V1, one or more display units 11, one or more projection units 12, one or more position sensors 13, and 14 are provided as system equipment 10A necessary for the online conference.

In the venue V2, one or more display units 11, one or more projection units 12, one or more position sensors 13, and 14 are provided as system equipment 10B. In the venue V3, one or more display units 11, one or more projection units 12, one or more position sensors 13, and 14 are provided as the system equipment 10C. In the venue V4, one or more display units 11, one or more projection units 12, one or more position sensors 13, and 14 are provided as the system equipment 10C.

The examiner P11 in the venue V1 who wears the projection unit 12 included in the VR conferencing system can move as an avatar A11 in a virtual reality space of the VR examination place 20, change a posture of the avatar A11, and visually recognize a stereoscopic image 21 in the field of view at a position of the avatar A11 as an actually stereoscopically viewed image. The same applies to the examiners P21 to P41 in the other venues V2 to V4.

In practice, a stereoscopic image that can be three-dimensionally recognized can be displayed by providing a parallax between an image shown on the left eye and an image shown on the right eye of the examiner P11 from the projection display using a VR goggle 15 and the like described later.

The VR examination place 20 is a three-dimensional space virtually formed in the processing of a computer, and is formed, for example, as a box-shaped space that is the same as a room of a general conference hall. In the example shown in FIG. 1, the stereoscopic image 21 generated based on design data of a wire harness developed as a product is virtually present in a space of the VR examination place 20.

Details are described later, and more specifically, both a three-dimensional model representing a shape and the like of a wire harness when the wire harness is assembled to a vehicle body and a three-dimensional model representing a shape of a wire harness developed on a jig plate when the wire harness is manufactured are included in the stereoscopic image 21. In addition, a stereoscopic image of the avatar A11, which is a character (doll or the like) corresponding to the examiner P11 in the venue V1, is disposed in a space of the VR examination place 20. Stereoscopic images of the avatars A21 to A24 corresponding to the respective examiners P21 to P41 in the other venues V2 to V4 are also disposed in the space of the VR examination place 20.

When the examiner P11 moves in a reality space in the venue V1, the position sensors 13 and 14 provided in the venue V1 detect a position change of the examiner P11. An actual three-dimensional position change of the examiner P11 detected by the position sensors 13 and 14 is reflected in a three-dimensional position change of the avatar A11 in the virtual space of the VR examination place 20. Further, an actual posture change of the examiner P11 is detected by the projection unit 12 worn by the examiner P11, and the result is reflected in the posture change of the avatar A11 in the VR examination place 20. The same applies to the examiners P21 to P41 and the avatars A21 to A41 in the other venues V2 to V4.

On the other hand, the display unit 11 disposed in the venue V1 is, for example, a computer including a two-dimensional display such as a notebook computer (PC), and is connected to be able to cooperate with the projection unit 12 in the venue V1. Specifically, an image of the VR examination place 20 in substantially the same range as a video shown in the field of view of the examiner P11 who wears the projection unit 12 in the venue V1 is displayed on a screen of the display unit 11 in a state synchronized with a position and posture of the projection unit 12. Of course, the screen of the display unit 11 is a two-dimensional display, and the stereoscopic image 21 in the VR examination place 20 is converted into a two-dimensional image and displayed on a two-dimensional screen of the display unit 11.

Similarly, the display unit 11 in the venue V2 can display, on the screen of the display unit 11 in the state synchronized with the position and posture of the projection unit 12, an image of the VR examination place 20 in substantially the same range as a video shown in the field of view of the examiner P21 who wears the projection unit 12 in the venue V2. The display unit 11 in the venue V3 can display, on the screen of the display unit 11 in the state synchronized with the position and posture of the projection unit 12, an image of the VR examination place 20 in substantially the same range as a video shown in the field of view of the examiner P31 who wears the projection unit 12 in the venue V3. The display unit 11 in the venue V4 can display, on the screen of the display unit 11 in the state synchronized with the position and posture of the projection unit 12, an image of the VR examination place 20 in substantially the same range as a video shown in the field of view of the examiner P41 who wears the projection unit 12 in the venue V4.

The display units 11 in the respective venues V1 to V4 are disposed on, for example, a desk. A microphone for collecting voice in the same venue and a speaker for voice amplification are also disposed on the same desk.

The examiner P11 in the venue V1 who wears the projection unit 12 can simultaneously move around a virtual space of the VR examination place 20 by moving around the venue V1 in the reality space. That is, an actual movement of the examiner P11 is reflected in a change in a position and a posture viewed by the examiner P11 in the VR examination place 20, and is also reflected in the contents of the field of view of the examiner P11 projected by the projection unit 12. The same applies to the examiners P21 to P41 in the other venues V2 to V4.

By actually moving around, the examiners P11 to P41 in the respective venues V1 to V4 can visually grasp in detail a state such as a three-dimensional shape of a part of a product or a jig to be examined in the VR examination place 20.

Further, since the avatars A11 to A41 corresponding to the examiners P11 to P41 in the respective venues V1 to V4 are present in the VR examination place 20, the examiners P11 to P41 can immediately grasp the positions and the postures, which are viewed by the examiners who are at the other sites, according to the images projected by the own projection unit 12. Therefore, it is easy for a plurality of examiners at different sites to simultaneously confirm and examine the same part of a product in the VR examination place 20.

Each of the participants P12 to P42 other than the examiners P11 to P41 in the respective venues V1 to V4 can also grasp a video of a part examined by the examiners P11 to P41 based on the contents displayed by the display unit 11.

On the other hand, as will be described later, the projection unit 12 at each site includes a user operation unit that receives an input operation of each of the examiners P11 to P41. The display unit 11 at each site also includes a user operation unit that receives an input operation of each of the participants P12 to P42.

Each of the examiners P11 to P41 can add a correction operation such as change, addition, or deletion to data of the stereoscopic image 21 in the VR examination place 20 by operating the user operation unit of the projection unit 12 worn by the examiners P11 to P41. The correction operation by each of the examiners P11 to P41 is recorded as data by the VR conferencing system, and is reflected in the stereoscopic image 21 in real time. As a result of the correction operation performed by any one of the examiners P11 to P41, the projection contents of the projection units 12 of all the examiners P11 to P41 and the display contents of the display units 11 of all the participants P12 to P42 are reflected in real time.

Therefore, all the examiners P11 to P41 present at different sites can simultaneously examine while confirming the same stereoscopic image 21 in substantially the same field of view using the common VR examination place 20, correct a shape, structure, layout, and the like of the product or jig projected as the stereoscopic image 21 as necessary, and confirm a correction result in real time. In addition, even for the participants P12 to P42 other than the examiners P11 to P41, by referring to a display screen of the display unit 11, it is possible to confirm a two-dimensional image corresponding to the stereoscopic image 21 at substantially the same field of view as that of the examiners P11 to P41 and simultaneously examine the two-dimensional image. Therefore, all participants of the online conference can efficiently perform the examination work.

### <Configuration of System>

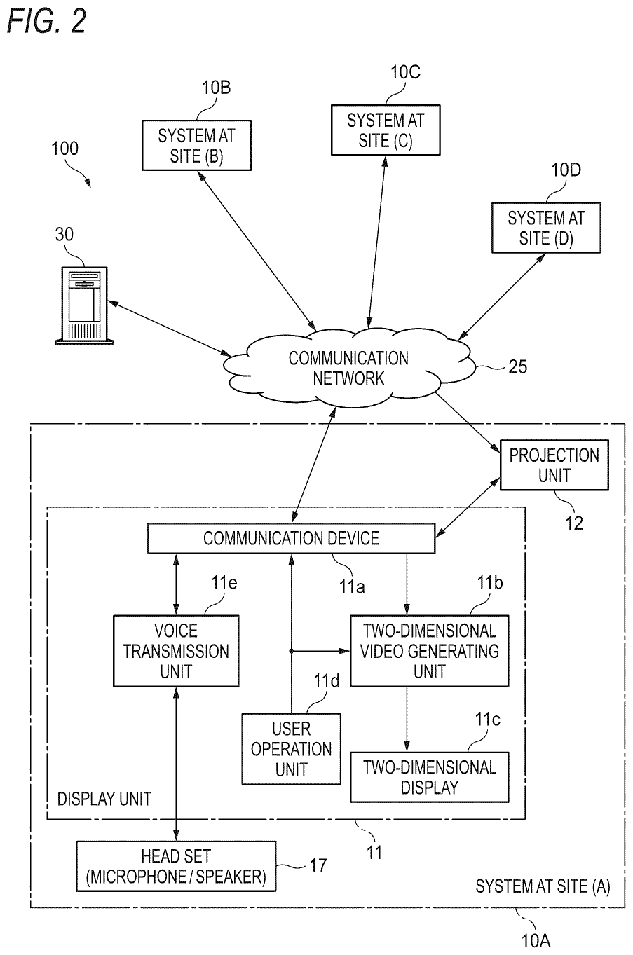

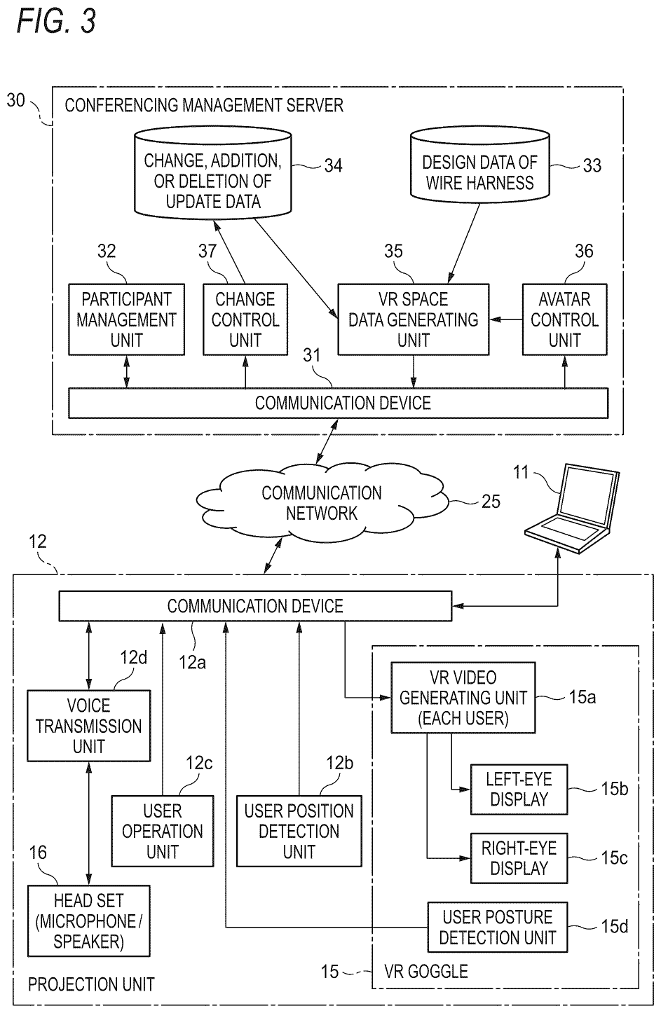

FIG. 2 is a block diagram showing a configuration example of the VR conferencing system 100. FIG. 3 is a block diagram showing a configuration example of a conferencing management server 30 and the projection unit 12.

In the example shown in FIG. 2, the system equipment 10A to 10D existing in the venues V1 to V4 at different sites H1 to H4 are connected to be able to communicate with each other via a communication network 25.

In order to enable simultaneous online conferences at the plurality of sites H1 to H4 using the common VR examination place 20, the conferencing management server 30 is connected to the communication network 25. The communication network 25 is assumed to include a local network existing in each of the sites H1 to H4, a dedicated communication line in a company, or a public communication line such as the Internet.

When the communication of the conference is performed via the Internet, the security of communication can be ensured by encrypting the data. In addition, the conferencing management server 30 may be provided at one place of the plurality of sites H1 to H4 or may be provided at a data center or the like at a place other than the sites H1 to H4.

The conferencing management server 30 shown in FIG. 3 includes a communication device 31, a participant management unit 32, database management units 33 and 34, a VR data generating unit 35, an avatar control unit 36, and a change control unit 37.

The communication device 31 has a function of safely performing data communication with the system equipment 10A to 10D at the respective sites H1 to H4 via the communication network 25.

The participant management unit 32 has a function of managing access to participants who participate in a common online conference with the examiners P11 to P41 or the participants P12 to P42.

The database management unit 33 holds and manages design data corresponding to the wire harness being developed. The design data includes data indicating shapes, dimensions, various components, and the like of parts of a target wire harness, and data indicating shapes and layouts of various jigs used for manufacturing the wire harness.

Design data representing a three-dimensional shape (a first stereoscopic image: a shape at the time of manufacturing) of the wire harness in a state of being developed on the jig plate and design data representing a three-dimensional shape (a second stereoscopic image: a shape at the time of assembling the wire harness to the vehicle body) of the wire harness in a state of being assembled to the vehicle are registered in the database management unit 33.

The database management unit 34 has a function of holding and managing update data indicating a correction portion for data of a specific version held by the database management unit 33. For example, data indicating that a shape of a specific part of the wire harness is changed, data indicating that a new component is added to the specific part of the wire harness, data indicating that a component of the specific part of the wire harness is deleted, and the like are sequentially registered and held in the database management unit 34 during the online conference.

The VR data generating unit 35 generates data of the stereoscopic image 21 disposed in a three-dimensional virtual space of the VR examination place 20. The data of the stereoscopic image 21 generated by the VR data generating unit 35 includes a stereoscopic image corresponding to the design data of the wire harness held by the database management unit 33, a stereoscopic image corresponding to each avatar managed by the avatar control unit 36, and a stereoscopic image corresponding to the update data managed by the database management unit 34.

The avatar control unit 36 has a function of constantly monitoring a position (three-dimensional coordinates) and posture (direction of the line of sight) of each of the examiners P11 to P41 and grasping a latest state while managing, as the avatars A11 to A41, characters in the VR examination place 20 corresponding to the examiners P11 to P41 at the respective sites H1 to H4 who participate in the online conference of the VR conferencing system 100.

The change control unit 37 has a function of receiving, as a correction instruction for the stereoscopic image 21 in the VR examination place 20, an input operation performed by the examiners P11 to P41 at the respective sites H1 to H4 who participate in the online conference of the VR conferencing system 100 to the user operation unit of the projection unit 12 and an input operation performed by the participants P12 to P42 at the respective sites H1 to H4 to a user operation unit of the display unit 11, and registering the input operations in the database management unit 34 as update data indicating change, addition, deletion, or the like to the stereoscopic image 21.

On the other hand, the projection unit 12 shown in FIG. 3 includes a communication device 12a, a user position detection unit 12b, a user operation unit 12c, a voice transmission unit 12d, the VR goggle 15, and a head set 16. The VR goggle 15 includes functions of a VR video generating unit 15a, a left-eye display 15b, a right-eye display 15c, and a user posture detection unit 15d. The head set 16 incorporates a microphone and a speaker.

The communication device 12a is connected to the conferencing management server 30 via the communication network 25, and can transmit and receive data to and from the conferencing management server 30. Specifically, the data of the stereoscopic image 21 in the VR examination place 20 is periodically acquired from the conferencing management server 30. The data of the stereoscopic image 21 acquired by the communication device 12a from the conferencing management server 30 includes design data such as three-dimensional shapes of the first stereoscopic image and the second stereoscopic image of the wire harness and a layout of the jigs and data of a three-dimensional shape, a position, and a posture of each of the avatars A11 to A41.

In addition, for example, the communication device 12a in the projection unit 12 at the site H1 can periodically transmit, to the conferencing management server 30, information on three-dimensional position coordinates of the examiner P11 detected by the position sensors 13 and 14 at the site H1 and the posture (direction of the line of sight) of the examiner P11 detected by the VR goggle 15 worn by the examiner P11.

Further, for example, the communication device 12a in the projection unit 12 at the site H1 is connected to the display unit 11 at the site H1, and it is possible to periodically transmit, to the display unit 11, information indicating a range of the field of view in a virtual reality space of the examiner P11 specified based on the three-dimensional position coordinates of the examiner P11 and the posture of the examiner P11.

The user position detection unit 12b can detect three-dimensional position coordinates and a change in the three-dimensional position coordinates in a reality space of each of the examiners P11 to P41 based on detection states of a pair of position sensors 13 and 14 disposed at parts facing the examiners P11 to P41 who wear the VR goggle 15 at the respective sites H1 to H4.

The user operation unit 12c is a device capable of receiving various button operations and coordinate input operations by a user, such as a mouse which is a general input device. In the present embodiment, the user operation unit 12c can receive input operations by the examiners P11 to P41 who wear the VR goggle 15 of the projection unit 12.

Specifically, the user operation unit 12c can perform a correction instruction such as change, addition, or deletion to the movement or the like of a user designated part in the stereoscopic image 21 of the VR examination place 20 projected from the VR goggle 15. In response to the instruction from the user operation unit 12c, the stereoscopic image 21 may be rotated in a three-dimensional space of the VR examination place 20, or a circuit configuration of the wire harness may be selected from a plurality of types of circuit configurations and reflected in the stereoscopic image 21 to be projected.

The voice transmission unit 12d can transmit, to another site via the communication device 12a and the communication network 25, information on voice uttered by an examiner taken in from the microphone of the head set 16. Further, the voice transmission unit 12d can receive information on voice uttered by an examiner at each of the other sites via the communication network 25 and the communication device 12a, and output the information as a voice from the speaker of the head set 16.

The VR goggle 15 have a function of projecting an image that can be three-dimensionally recognized on the left and right eyes of the user who wears the VR goggle 15.

The VR video generating unit 15a constantly recognizes a state of a position and posture (for example, direction of a line of sight) of a user (examiners P11 to P41) in the three-dimensional virtual space of the VR examination place 20, and specifies a range of the field of view of the user. Then, the VR video generating unit 15a acquires, from the conferencing management server 30, at least data in the range of the field of view of the user among the data of the stereoscopic image 21 existing in the three-dimensional virtual space of the VR examination place 20, and generates two types of two-dimensional image data viewed from viewpoint positions of the left and right eyes of the user by coordinate transformation of the data of the stereoscopic image 21.

The left-eye display 15b receives the left-eye two-dimensional image data generated by the VR video generating unit 15a from the VR video generating unit 15a, and projects the left-eye two-dimensional image data to a position of the left eye of the user as a two-dimensional image.

The right-eye display 15c receives the right-eye two-dimensional image data generated by the VR video generating unit 15a from the VR video generating unit 15a, and projects the right-eye two-dimensional image data to a position of the right eye of the user as a two-dimensional image.

The user posture detection unit 15d detects a direction of a line of sight of the user, for example, by tracking positions of the irises of the user captured by a camera or the like. Alternatively, an angle in a triaxial direction (roll angle, pitch angle, and yaw angle) indicating an orientation of a head of the user is detected using a triaxial acceleration sensor or the like. The posture of the user detected by the user posture detection unit 15d and the information on the position detected by the user position detection unit 12b are input to the conferencing management server 30 via the communication device 12a and the communication network 25. The position and posture of the user are reflected in the positions and the postures of the corresponding avatar A11 to A41 in the virtual reality space in the VR examination place 20 by a process of the conferencing management server 30.

On the other hand, the display unit 11 shown in FIG. 2 includes a communication device 11a, a two-dimensional video generating unit 11b, a two-dimensional display 11c, a user operation unit 11d, and a voice transmission unit 11e.

The communication device 11a is connected to the conferencing management server 30 via the communication network 25, and can transmit and receive data to and from the conferencing management server 30. Specifically, the data of the stereoscopic image 21 in the VR examination place 20 is periodically acquired from the conferencing management server 30.

The communication device 11a is connected to the projection unit 12 at the same site, and can acquire, from the projection unit 12, information necessary for synchronizing a range of the field of view of an examiner who wears the projection unit 12 and a display range of the display unit 11.

The two-dimensional video generating unit 11b specifies, from the information transmitted from the projection unit 12, the range of the field of view of the examiner who wears the projection unit 12 at the same site, and acquires, from the conferencing management server 30, the data of the stereoscopic image 21 present in the three-dimensional virtual space of the VR examination place 20 in a range equivalent to the field of view of the examiner. Then, two-dimensional image data of an image viewed from a viewpoint position of the examiner is generated by coordinate conversion of the data of the stereoscopic image 21.

The two-dimensional display 11c displays the two-dimensional image data generated by the two-dimensional video generating unit 11b on a screen as a two-dimensional image. The display unit 11 may acquire, from the projection unit 12, any one of the two types of two-dimensional image data for the left and right eyes generated by the VR video generating unit 15a of the VR goggle 15, and display the data on the two-dimensional display 11c.

The user operation unit 11d is a device capable of receiving various button operations and coordinate input operations by a user, such as a mouse or a keyboard which is a general input device. In the present embodiment, the user operation unit 11d can receive input operations by the participants P12 to P42. Specifically, the user operation unit 11d can perform a correction instruction such as change, addition, or deletion to the movement or the like of a user designated part in the stereoscopic image 21 of the VR examination place 20 displayed on a screen of the two-dimensional display 11c. In response to the instruction from the user operation unit 11d, the stereoscopic image 21 may be rotated in a three-dimensional space of the VR examination place 20, or a circuit configuration of the wire harness may be selected from a plurality of types of circuit configurations and reflected in the stereoscopic image 21 to be projected.

The voice transmission unit 11e can transmit, to another site via the communication device 11a and the communication network 25, information on voice uttered by a participant taken in from a microphone of the head set 17. Further, the voice transmission unit 11e can receive information on voice uttered by an examiner or a participant at each of the other sites via the communication network 25 and the communication device 11a, and output the information as a voice from a speaker of the head set 17.

### <Overview of Operation of System>

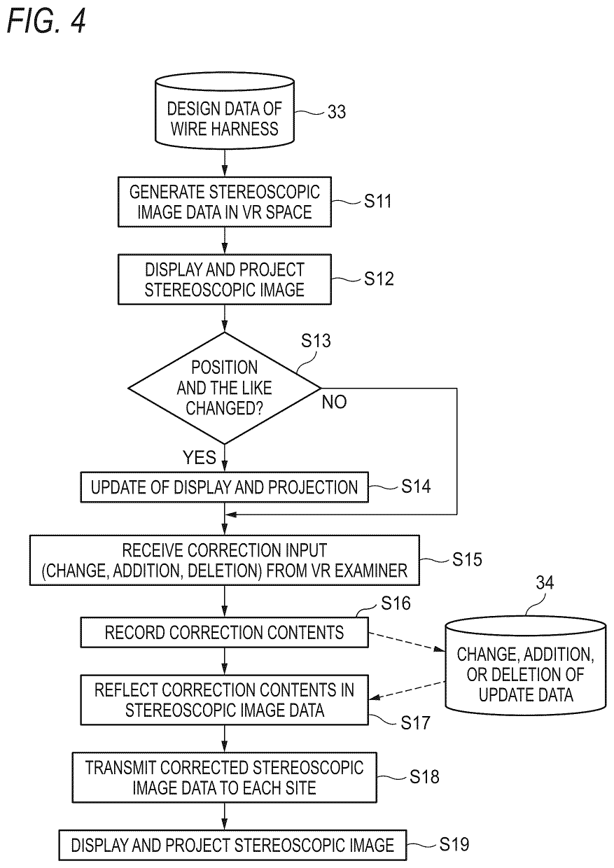

FIG. 4 shows an outline of a flow of processes in an operation example of the VR conferencing system 100. The processes shown in FIG. 4 will be described below.

The VR data generating unit 35 on the conferencing management server 30 generates three-dimensional data of the stereoscopic image 21 in the VR space of the VR examination place 20 based on the design data of the wire harness held by the database management unit 33 (S11). For each of the avatars A11 to A41 managed by the avatar control unit 36, the VR data generating unit 35 also generates three-dimensional data of the stereoscopic image 21 in the VR space of the VR examination place 20. When the database management unit 34 holds the update data, the data of the stereoscopic image 21 is corrected by reflecting the content of the update data.

When the online conference is started using the VR conferencing system 100, the projection unit 12 worn by the examiners P11 to P41 at the sites and the display unit 11 used by the participants P12 to P42 are connected to the conferencing management server 30 via the communication network 25 so that the projection unit 12, the display unit 11, and the conferencing management server 30 can communicate with each other.

The projection unit 12 at each site acquires the data of the stereoscopic image 21 in the VR examination place 20 generated by the VR data generating unit 35 of the conferencing management server 30, performs coordinate conversion of the data to be a stereoscopic image shown in the field of view of each of the right and left eyes of each of the examiners P11 to P41, and projects the stereoscopic image so that the respective examiners P11 to P41 can visually recognize the stereoscopic image by the VR goggle 15 (S12).

Further, the display unit 11 at each site acquires the data of the stereoscopic image 21 in the VR examination place 20 generated by the VR data generating unit 35 of the conferencing management server 30, performs coordinate conversion of the data to substantially match a stereoscopic image shown in the field of view of each of the examiners P11 to P41 in the same site, and displays the data on the screen of the two-dimensional display 11c (S12).

When each of the examiners P11 to P41 moves in the reality space or changes the posture or the line of sight while visually recognizing the stereoscopic image projected from the VR goggle 15, the change is detected by the user position detection unit 12b and the user posture detection unit 15d. The change in the posture and the line of sight of each of the examiners P11 to P41 in the reality space is reflected in the change of the field of view in the VR examination place 20 of the examiner.

The VR video generating unit 15a of the VR goggle 15 updates the stereoscopic image to be projected on the left-eye display 15b and the right-eye display 15c in accordance with the change in the field of view of the examiner (S13) (S14). In addition, the two-dimensional video generating unit 11b of the display unit 11 updates the image displayed on the two-dimensional display 11c so as to follow the change in the field of view of the examiner (S13) present at the same site (S14).

By operating the user operation unit 12c, the examiners P11 to P41 at the respective sites can change a part of interest of a stereoscopic image shown in his or her field of view as necessary (S15). In the present specification, the term “change” includes meanings of “addition” and “deletion”. For example, it is possible to change a shape of a part of interest of the wire harness, move a position at which each jig is disposed, and add or delete a component or a jig of the wire harness in the process of S15.

The correction input by an input operation of the examiners P11 to P41 at the respective sites is input from the projection unit 12 to the conferencing management server 30 via the communication network 25. The change control unit 37 of the conferencing management server 30 receives the correction input from each of the examiners P11 to P41 and records the contents thereof as update data in the database management unit 34 (S16).

When the VR data generating unit 35 of the conferencing management server 30 detects that new update data is added to the database management unit 34, the VR data generating unit 35 of the conferencing management server 30 generates new data of the stereoscopic image 21 by reflecting the correction contents of the update data in the stereoscopic image 21 of the VR examination place 20 generated by the VR data generating unit 35 (S17).

The communication device 31 of the conferencing management server 30 transmits, to each of the system equipment 10A to 10D at the respective sites H1 to H4, the corrected data of the stereoscopic image 21 generated by the VR data generating unit 35 (S18).

The projection unit 12 at each site acquires the data of the corrected stereoscopic image 21 transmitted from the conferencing management server 30, performs coordinate conversion of the data to be a stereoscopic image shown in the field of view of each of the right and left eyes of each of the examiners P11 to P41, and projects the stereoscopic image so that the respective examiners P11 to P41 can visually recognize the stereoscopic image by the VR goggle 15 (S19).

Further, the display unit 11 at each site acquires the corrected data of the stereoscopic image 21 transmitted from the conferencing management server 30, performs coordinate conversion of the data to substantially match a stereoscopic image shown in the field of view of each of the examiners P11 to P41 in the same site, and displays the data on the screen of the two-dimensional display 11c (S19).

Therefore, by using the VR conferencing system 100 shown in FIGS. 2 and 3, as shown in FIG. 1, all of the examiner P11 and the participant P12 at the site H1, the examiner P21 and the participant P22 at the site H2, the examiner P31 and the participant P32 at the site H3, and the examiner P41 and the participant P42 at the site H4 can hold an online conference using the virtual reality space of the common VR examination place 20 without moving.

In particular, the examiners P11 to P41 can stereoscopically recognize the stereoscopic image 21 projected by the VR goggle 15 in the same manner as a real object, and the movement and posture change of the examiners P11 to P41 are reflected in the fields of view of the examiners P11 to P41 in the space of the VR examination place 20, and thus it is easy to confirm in detail a three-dimensional shape and structure of a part required to be examined.

In addition, since the avatars A11 to A41 corresponding to the examiners P11 to P14 at the respective sites are included in the stereoscopic image 21 in the VR examination place 20, the examiners P11 to P14 can also recognize a part on the wire harness, a direction of a line of sight, and the like confirmed by other examiners. That is, the examiners P11 to P14 can easily grasp a relative positional relation or the like between the examiners while being present at sites of different places, and thus it is possible to efficiently perform an operation of confirming a common target part on the stereoscopic image 21 by all the examiners as in the case of holding a conference in a common reality space.

Further, the examiners P11 to P14 at the respective sites can perform a correction operation such as change, addition, or deletion on the stereoscopic image 21 by performing an input operation as necessary. In addition, by reflecting a result of the correction operation on the content of the projected stereoscopic image 21, the examiners P11 to P14 at the respective sites can easily grasp a three-dimensional shape and a structure of the corrected stereoscopic image 21.

In addition, the participants P12 to P42 at the respective sites can confirm a two-dimensional image in substantially the same range as the stereoscopic image 21 reflected in the field of view of the examiners P11 to P14 at the same site on the screen display of the display unit 11. Therefore, even in a case where there is no real model or the like in each of the venues V1 to V4, the participants P12 to P42 also easily grasp a shape and structure of the part to be examined, similarly to the examiners P11 to P14.

### Specific Example of Stereoscopic Image

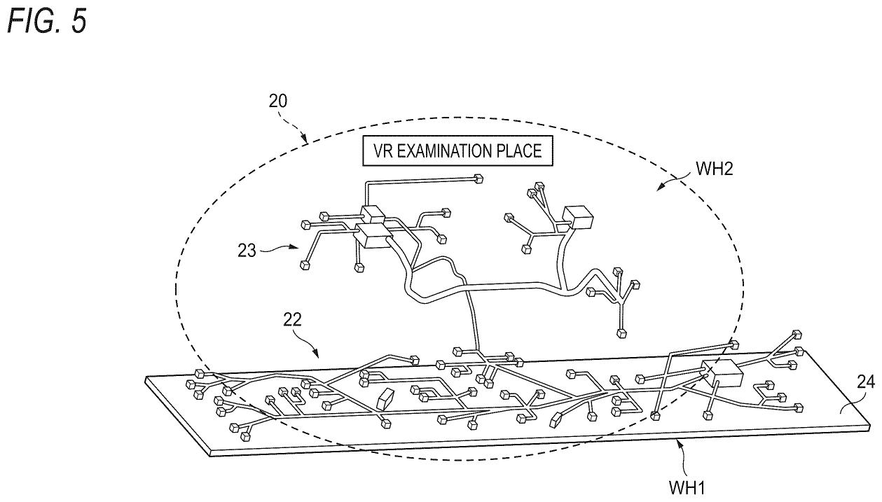

FIG. 5 is a schematic diagram showing a representative example of the stereoscopic image 21 formed in the VR examination place 20.

As shown in FIG. 5, the stereoscopic image 21 formed in the VR examination place 20 includes both a first stereoscopic image 22 and a second stereoscopic image 23.

A shape of the wire harness WH2 of the second stereoscopic image 23 is determined based on design data of the wire harness WH2 such that the shape of the wire harness WH2 matches a three-dimensional shape of a wiring state in which the wire harness is actually assembled to the vehicle.

On the other hand, a shape of the wire harness WH1 of the first stereoscopic image 22 is determined based on design data of the wire harness WH1 such that the shape of the wire harness WH1 matches a three-dimensional shape of a wiring state of a group of electric wires of each part in an actual wire harness manufacturing process. That is, the wire harness WH1 of the first stereoscopic image 22 represents a three-dimensional shape in a case where the shape of the wire harness WH2 is flatly developed and disposed on an upper face of the jig plate 24 having a flat plate shape.

Therefore, the two types of wire harnesses WH1 and WH2 are products having the same structure, but only three-dimensional shapes are different from each other. Specifically, the shape of the wire harness WH2 of the second stereoscopic image 23 has a shape having large undulations in a vertical direction so as to match a shape of a space in the vehicle. In the wire harness WH1, the group of electric wires of each part is disposed along each jig position on the upper face of the jig plate 24, and thus the shape of the wire harness WH1 of the first stereoscopic image 22 is a shape in which the undulations in the vertical direction are small.

A user of the VR conferencing system 100 can compare and examine both the first stereoscopic image 22 and the second stereoscopic image 23 by visually recognizing the stereoscopic image 21 of the VR examination place 20 using the display unit 11 or the projection unit 12.

<Positional Relation between First Stereoscopic Image and Second Stereoscopic Image>

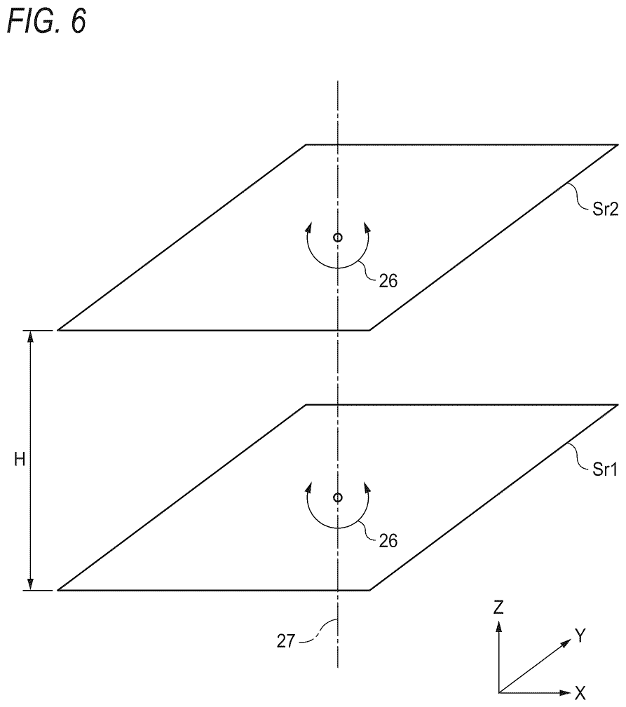

FIG. 6 is a schematic diagram showing an example of two reference planes Sr1 and Sr2 that determine a positional relation between the first stereoscopic image 22 and the second stereoscopic image 23. Coordinates of each part in the three-dimensional space of the VR examination place 20 can be represented by positions in axial directions X, Y, and Z as shown in FIG. 6.

When the two types of the first stereoscopic image 22 and the second stereoscopic image 23 are expressed simultaneously as the stereoscopic image 21 as shown in FIG. 5, the first stereoscopic image 22 and the second stereoscopic image 23 are respectively aligned with two reference planes Sr1 and Sr2 parallel to each other, which are shifted by a certain distance H in a height direction (a Z-axis direction). As a result, the first stereoscopic image 22 and the second stereoscopic image 23 are disposed at positions adjacent to each other, and thus it is easy for the examiner to compare and examine the first stereoscopic image 22 and the second stereoscopic image 23.

Specifically, when the first stereoscopic image 22 is disposed in the space of the VR examination place 20, for example, it is assumed that the coordinates of the first stereoscopic image 22 are aligned in a state in which an upper face position of the jig plate 24 matches the reference plane Sr1 in FIG. 6. When the second stereoscopic image 23 is disposed in the space of the VR examination place 20, for example, it is assumed that the second stereoscopic image 23 is aligned in a state in which a plane position of a floor surface in a vehicle interior matches the reference plane Sr2 in FIG. 6.

Accordingly, the first stereoscopic image 22 and the second stereoscopic image 23 can be disposed substantially in parallel in a state of being adjacent to each other in the vertical direction, and the stereoscopic image 21 as shown in FIG. 5 can be displayed in the VR examination place 20.

In addition, the stereoscopic image 21 can be rotated by coordinate conversion in the VR examination place 20. For example, the first stereoscopic image 22 and the second stereoscopic image 23 are rotated in a rotation direction 26 about a rotation axis 27 passing through center positions of the reference planes Sr1 and Sr2 shown in FIG. 6. Accordingly, even if the examiners P11 to P41 and the like do not move, the part of the stereoscopic image 21 shown in the field of view of each examiner can be switched.

### <Process of Display Operation>

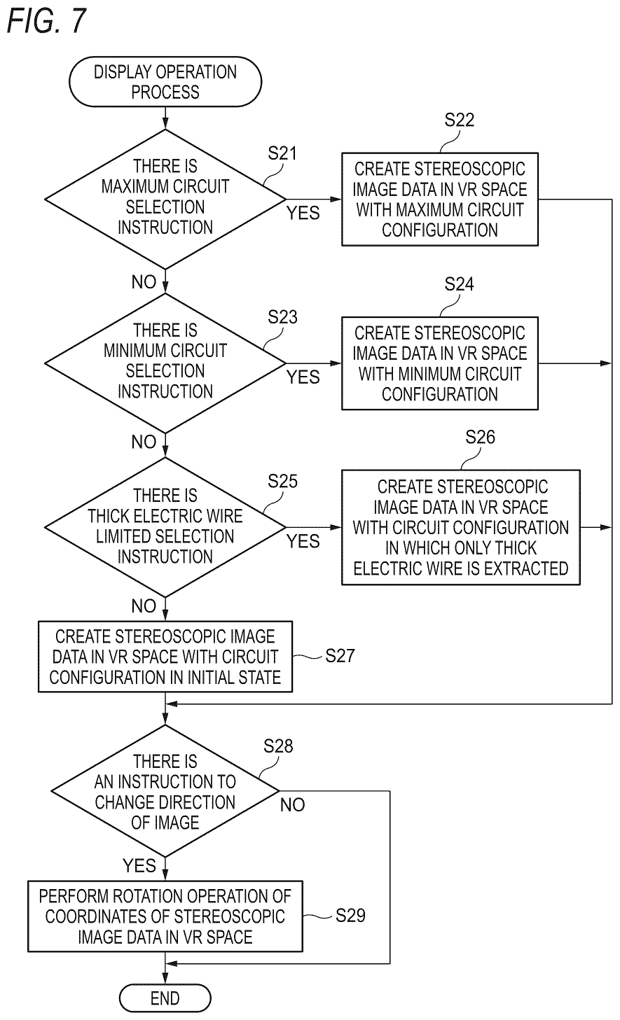

FIG. 7 is a flowchart showing an example of a process for a display operation of a user. For example, in response to an input operation of the user on the user operation unit 12c or 11d, the projection unit 12, the display unit 11, or the conferencing management server 30 executes the process of FIG. 7. The process in FIG. 7 will be described below.

In the present embodiment, it is assumed that the stereoscopic image 21 can be selectively displayed on each of the wire harnesses having a circuit configuration of an initial state determined in advance, a maximum circuit configuration, a minimum circuit configuration, and a circuit configuration of only a thick electric wire.

The maximum circuit configuration refers to a configuration of a wire harness that has a function of a wire harness connectable to all electric components that can be mounted on the same type of vehicles including options, and has the maximum number of components and the maximum number of electric wires. The minimum circuit configuration refers to a configuration of a wire harness that has a function of connecting to an electric component of a minimum limit required for a vehicle having a basic configuration (for example, a base grade) not including an option, and has the minimum number of components and the minimum number of electric wires. The circuit configuration of only the thick electric wire refers to a configuration limited to only a circuit using a thick electric wire such as a power supply line or a ground line among various circuits constituting the wire harness.

When the user instructs the user operation unit 12c or 11d to select the maximum circuit configuration, the VR data generating unit 35 of the conferencing management server 30 extracts design data of the wire harnesses WH1 and WH2 having the maximum circuit configuration from the database management unit 33, and generates data of the first stereoscopic image 22 and the second stereoscopic image 23 in the VR space of the VR examination place 20 (S22).

When the user instructs the user operation unit 12c or 11d to select the minimum circuit configuration, the VR data generating unit 35 of the conferencing management server 30 extracts design data of the wire harnesses WH1 and WH2 having the minimum circuit configuration from the database management unit 33, and generates data of the first stereoscopic image 22 and the second stereoscopic image 23 in the VR space of the VR examination place 20 (S24).

When the user instructs the user operation unit 12c or 11d to select the thick electric wire limited circuit configuration, the VR data generating unit 35 of the conferencing management server 30 extracts design data of the wire harnesses WH1 and WH2 having the thick electric wire limited circuit configuration from the database management unit 33, and generates data of the first stereoscopic image 22 and the second stereoscopic image 23 in the VR space of the VR examination place 20 (S26).

When the user does not instruct the selection of the configuration, the VR data generating unit 35 of the conferencing management server 30 extracts design data of the wire harnesses WH1 and WH2 having the circuit configuration in the initial state determined in advance from the database management unit 33, and generates the data of the first stereoscopic image 22 and the second stereoscopic image 23 in the VR space of the VR examination place 20 (S27).

When the user instructs the user operation unit 12c or 11d to perform a rotation operation of a stereoscopic image, the VR data generating unit 35 of the conferencing management server 30 performs coordinate conversion of data of the first stereoscopic image 22 and the second stereoscopic image 23 in the VR space of the VR examination place 20 in accordance with a rotation direction and a rotation angle in the VR space, and generates data after the rotation operation (S29).

### <Process of Change Operation>

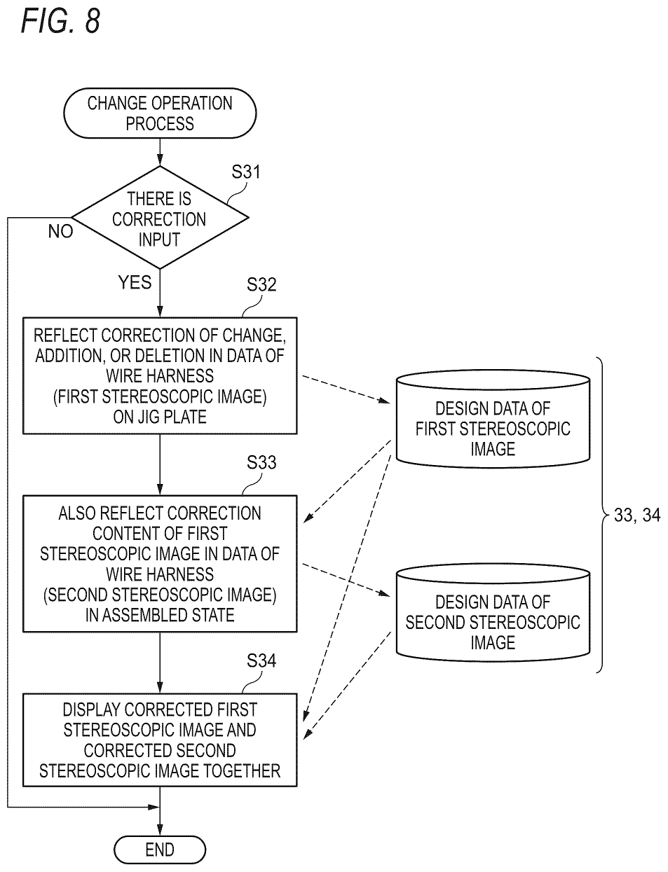

FIG. 8 is a flowchart showing an example of a process corresponding to a change operation of the user. For example, in response to an input operation of the user on the user operation unit 12c or 11d, the projection unit 12, the display unit 11, or the conferencing management server 30 executes the process of FIG. 8. The processes in FIG. 8 will be described below.

By operating the user operation units 12c and 11d, the examiners P11 to P41 and the participants P12 to P42 can change a part of interest of a stereoscopic image shown in his or her field of view as necessary. For example, it is possible to change a shape of a part of interest of the wire harness, move a position at which each jig is disposed, and perform a correction operation of adding or deleting a component or a jig of the wire harness.

Here, as shown in FIG. 5, the wire harness WH1 in a state of being developed on a jig plate as a wire harness to be corrected and the wire harness WH2 in a state of being assembled to a vehicle are present on the VR examination place 20, and in the present embodiment, the first stereoscopic image 22 of the wire harness WH1 is preferentially corrected.

That is, the correction input of the user is first reflected as change, addition, or deletion for a part of the first stereoscopic image 22, and is reflected in the design data of the database management units 33 and 34 (S32).

Next, the content of the corrected first stereoscopic image 22 is reflected as change, addition, or deletion to a part of the second stereoscopic image 23 of the wire harness WH2, and is also reflected in the design data of the database management units 33 and 34 (S33).

Further, both data of the corrected first stereoscopic image 22 and the corrected second stereoscopic image 23 are displayed on the display unit 11 and the projection unit 12 as the contents of the VR examination place 20 (S34).

The present disclosure is not limited to the above-described embodiment, and may be appropriately modified, improved, and the like. In addition, materials, shapes, sizes, numbers, disposition places and the like of components in the embodiment described above are freely selected and are not limited as long as the present disclosure can be implemented.

For example, in the above-described embodiment, the VR conferencing system 100 capable of performing the online conference simultaneously at a plurality of sites has been described, and the stereoscopic image display system according to the present disclosure can be implemented using one or more projection units 12 disposed at one site. A function equivalent to the conferencing management server 30 may be incorporated in the projection unit 12, or the conferencing management server 30 may be disposed in the vicinity of the projection unit 12.

Characteristic matters regarding the above stereoscopic image display system are briefly summarized in the following [1] to [5]. [1] A stereoscopic image display system includes:
a stereoscopic image generation device (the VR data generating unit 35) configured to generate stereoscopic image data of a wire harness based on design data of the wire harness; and
a projection unit (12) configured to acquire the stereoscopic image data from the stereoscopic image generation device and project a stereoscopic image based on the stereoscopic image data into a VR space that can be recognized by a user, in which
the stereoscopic image data includes first stereoscopic image data representing the wire harness (WH1) in a state of being developed on a jig plate (24) and second stereoscopic image data representing the wire harness (WH2) in a state of being assembled to a vehicle, and
the projection unit aligns and projects a first stereoscopic image (22) based on the first stereoscopic image data and a second stereoscopic image (23) based on the second stereoscopic image data in such a manner that the first stereoscopic image (22) and the second stereoscopic image (23) are positioned adjacent to each other (FIG. 5).

The projection unit (12) projects the first stereoscopic image and the second stereoscopic image in such a manner that a first reference plane (Sr1) in the first stereoscopic image and a second reference plane (Sr2) in the second stereoscopic image are aligned in parallel with each other in a state where the reference planes are separated from each other by at least a certain distance (H) in a vertical direction.

According to the stereoscopic image display system having a configuration of the above [1], it is easy for the user to simultaneously compare and examine a shape of a wire harness in a state of being developed on a jig plate and a shape of the same wire harness in a state of being assembled to a vehicle, based on the recognition of a stereoscopic image projected by a projection unit. In addition, a shape of each part of the wire harness can be three-dimensionally recognized by the user in the VR space, thereby facilitating the confirmation of the shape of the details.

[2] The stereoscopic image display system according to [1], further including
an input operation unit (the user operation unit 12c) configured to receive an input operation of the user, in which
the projection unit includes a display direction changing unit (S28, S29) that changes directions of the first stereoscopic image and the second stereoscopic image to be projected by reflecting an input from the input operation unit.

According to the stereoscopic image display system having a configuration of the above [2], since the directions of the first stereoscopic image and second stereoscopic image to be projected can be changed in the VR space, even if the user actually moves and does not move a viewpoint of the user in the VR space, the parts of the same wire harness can be seen from different directions.

[3] The stereoscopic image display system according to [1] or [2], further including
an input operation unit (the user operation unit 12c) capable of receiving an input operation of the user, in which
the projection unit, or the stereoscopic image generation device includes a change processing unit (S31, S32) that performs a process of changing, adding, and/or deleting the first stereoscopic image by reflecting an input from the input operation unit, and a processing reflection unit (S33) that reflects, on the second stereoscopic image, a result of the process for the first stereoscopic image.

According to the stereoscopic image display system having a configuration of the above [3], it is possible to add a change to the first stereoscopic image to solve a problem in manufacturing a target wire harness by the input operation of the user. In addition, by reflecting the change of the first stereoscopic image on the second stereoscopic image, the user can easily confirm how many new problems occur in a state where the changed wire harness is assembled to the vehicle.

[4] The stereoscopic image display system according to any one of [1] to [3], further including
an input operation unit capable of receiving an input operation of the user, in which
the projection unit, or the stereoscopic image generation device includes a display selection unit (S21 to S27) that reflects an input from the input operation unit and enables selection and display of at least one of a stereoscopic image having a maximum circuit configuration, a stereoscopic image having a minimum circuit configuration, and a stereoscopic image having a circuit configuration limited to only a part.

According to the stereoscopic image display system having a configuration of the above [4], a more appropriate stereoscopic image can be selectively projected according to a problem or purpose to be examined by the user. For example, by projecting an image limited only to a component of the thick electric wire among the group of electric wires constituting the wire harness, it is easy to examine the ease of bending when the thick electric wire is bent in accordance with a routing path on the vehicle and a change in a distal end position in detail.

[5] The stereoscopic image display system according to any one of [1] to [4], in which
the projection unit aligns the first stereoscopic image in a state in which an upper face position of the jig plate matches the first reference plane, and aligns the second stereoscopic image in a state in which a plane position of a floor surface in a vehicle interior matches the second reference plane.

According to the stereoscopic image display system having a configuration of the above [5], since the first stereoscopic image and the second stereoscopic image slightly different in shape from each other are projected side by side in a substantially parallel state, the user can easily grasp a difference in shape and a difference in position by comparing the two images.

The present application is based on Japanese Patent Application No. 2022-52162 filed on Mar. 28, 2022, the contents of which are incorporated herein by reference.

What is claimed is:

1. A stereoscopic image display system comprising:
a stereoscopic image generation device configured to generate stereoscopic image data of a wire harness based on design data of the wire harness; and
a projection unit configured to acquire the stereoscopic image data from the stereoscopic image generation device and project a stereoscopic image based on the stereoscopic image data into a VR space that can be recognized by a user, wherein
the stereoscopic image data includes a first stereoscopic image data representing the wire harness in a state of being developed on a jig plate and a second stereoscopic image data representing the wire harness in a state of being assembled to a vehicle,
the projection unit aligns and projects a first stereoscopic image based on the first stereoscopic image data and a second stereoscopic image based on the second stereoscopic image data in such a manner that the first stereoscopic image and the second stereoscopic image are positioned adjacent to each other, and
the projection unit projects the first stereoscopic image and the second stereoscopic image in such a manner that a first reference plane in the first stereoscopic image and a second reference plane in the second stereoscopic image are aligned in parallel with each other in a state where the first reference plane and the second reference plane are separated from each other by at least a certain distance in a vertical direction.

2. The stereoscopic image display system according to claim 1, further comprising
an input operation unit configured to receive an input operation of the user,
wherein the projection unit includes a display direction changing unit that changes directions of the first stereoscopic image and the second stereoscopic image to be projected by reflecting an input from the input operation unit.

3. The stereoscopic image display system according to claim 1, further comprising
an input operation unit configured to receive an input operation of the user,
wherein the projection unit or the stereoscopic image generation device includes a change processing unit that performs a process of changing, adding, or deleting the first stereoscopic image by reflecting an input from the input operation unit, and a processing reflection unit that reflects, on the second stereoscopic image, a result of the process for the first stereoscopic image.

4. The stereoscopic image display system according to claim 1, further comprising
an input operation unit configured to receive an input operation of the user,
wherein the projection unit, or the stereoscopic image generation device includes a display selection unit that reflects an input from the input operation unit and enables selection and display of at least one of a stereoscopic image having a maximum circuit configuration, a stereoscopic image having a minimum circuit configuration, and a stereoscopic image having a circuit configuration limited to only a part.

5. The stereoscopic image display system according to claim 1, wherein
the projection unit aligns the first stereoscopic image in a state in which an upper face position of the jig plate matches the first reference plane, and aligns the second stereoscopic image in a state in which a plane position of a floor surface in a vehicle interior matches the second reference plane.
